(19) United States
(12) Patent Application Publication
(10) Pub. No.: US 2017/0345150 A1
(43) Pub. Date: Nov. 30, 2017

(54) IMAGE PROCESSING SYSTEM AND METHOD

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventor: WEI-FENG SUN, New Taipei (TW)

(21) Appl. No.: 15/250,956

(22) Filed: Aug. 30, 2016

(30) Foreign Application Priority Data
May 26, 2016 (TW) 105116535

(51) Int. Cl. G06T 7/00; G06T 7/60

(52) U.S. Cl. CPC G06T 7/0081; G06T 7/602; G06T 2207/20144

(57) ABSTRACT

An image processing system able to distinguish between foreground and background objects in an image includes an object obtaining module, a foreground object, a sampling module, a fitting module, and a background object. The object obtaining module obtains objects of an image according to pixel values of pixels of the image, these values being all greater than a preset pixel value. The foreground object determining module determines between foreground and background objects. The sampling module samples a plurality of pixels of each background object. The fitting module obtains a pixel value function related to positions of pixels of the background object according to sampled pixel values. The background object removing module subtracts the pixel values of background objects by the pixel value of each pixel of the image to obtain foreground objects. An image processing method is also disclosed.

### CROSS-REFERENCE TO RELATED APPLICATIONS

This application claims priority to Taiwan Patent Application No. 105116535, filed on May 26, 2016, the contents of which are incorporated by reference herein.

### FIELD

The subject matter herein generally relates to image processing systems.

### BACKGROUND

During picture segmentations, a foreground area and a background area may be distinguished. Threshold values of a number of pixels are defined. A value of each pixel is compared to the threshold value to distinguish the foreground area and the background area, which costs a lot of time.

### BRIEF DESCRIPTION OF THE DRAWINGS

Implementations of the present technology will now be described, by way of example only, with reference to the attached figures.

FIG. 1 is a block diagram of an image processing system.

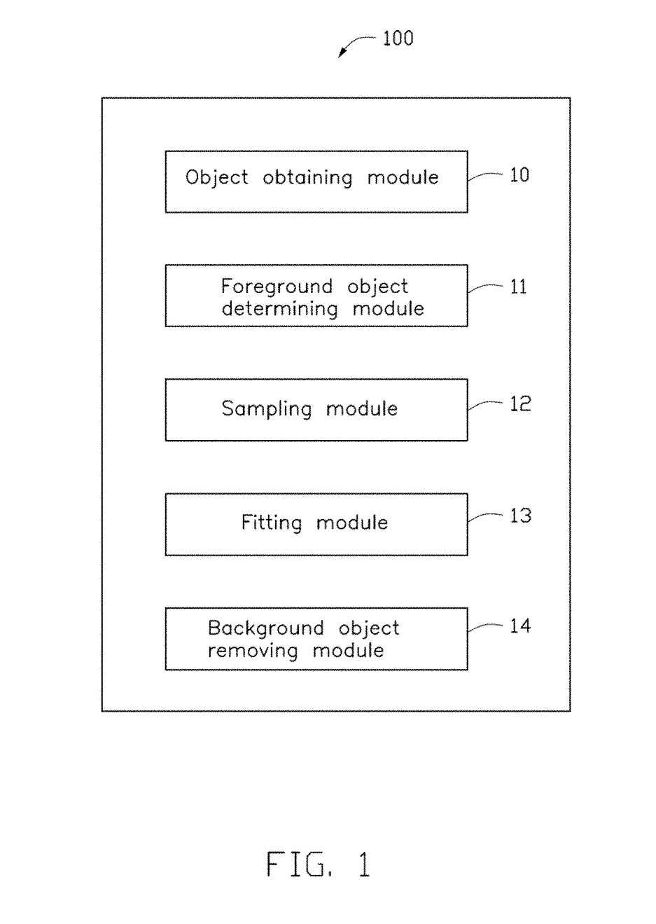

FIG. 2 is a schematic view of a number of objects within an image for processing in the system.

FIG. 3 is a schematic view of a number of sampled pixels of a background object within an image.

FIG. 4 is a schematic view of pixel values of a background object within an image according to a pixel value function.

FIG. 5 is a schematic view of an image to be processed.

FIG. 6 is a schematic view of a foreground object within the image in FIG. 5.

FIG. 7 is a flowchart of an image processing method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

A definition that applies throughout this disclosure will now be presented.

The term “comprising” means “including, but not necessarily limited to”; it specifically indicates open-ended inclusion or membership in a so-described combination, group, series, and the like.

The instant disclosure provides an image processing system 100. The image processing system 100 includes an object obtaining module 10, a foreground object determining module 11, a sampling module 12, a fitting module 13, and a background object removing module 14. The processing system 100 further includes at least one processor (not shown) for executing programs associated with at least one of the object obtaining module 10, the foreground object determining module 11, the sampling module 12, the fitting module 13 and the background object removing module 14.

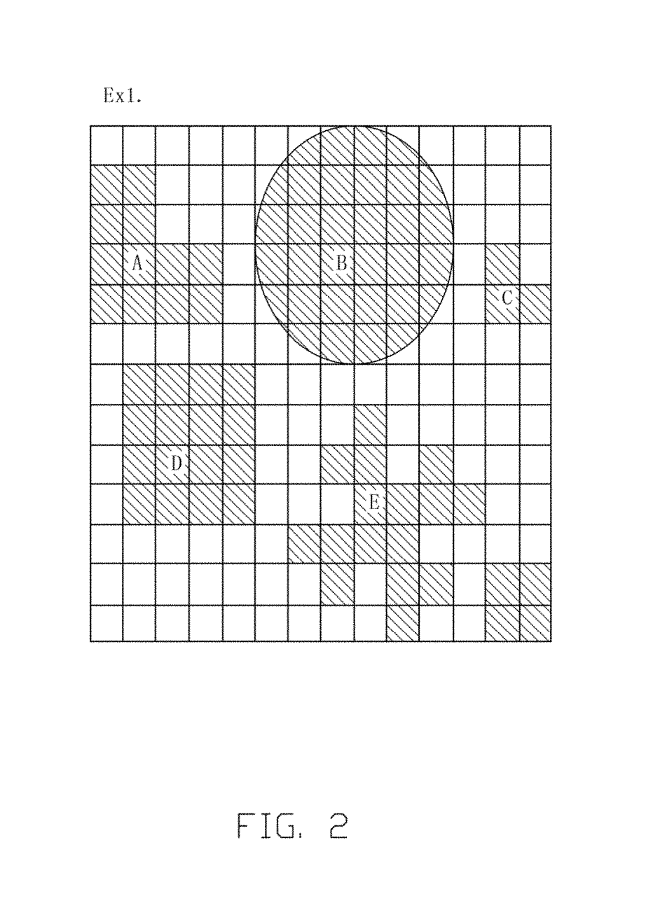

The object obtaining module 10 is configured to obtain a number of objects within the image according to pixel values of pixels of the image. The pixel values of the pixels carrying the object or part of it are all greater than a preset pixel value. FIG. 2 illustrates an image which includes objects A, B, C, D, E, and F. The pixel values of the pixels of the objects A, B, C, D, E, and F are all greater than a preset pixel value. The pixel values of other areas in the image are all smaller than the preset pixel value.

The foreground object determining module 11 is configured to determine an object in the foreground of the image. In an embodiment, the foreground object determining module 11 compares each object to a preset picture and determines a foreground object according to a similarity between the object and the preset picture. When the similarity of the object and the preset picture is greater than a preset value, the foreground object determining module determines that the object is a foreground object. When the similarity of the object and the preset picture is smaller than the preset value, the foreground object determining module determines that the object is a background object.

In another embodiment, the foreground object determining module 11 is configured to calculate a compactness of each object and determine an object to be in the foreground or not to be in the foreground according to the compactness of each object and a preset compactness range. The compactness is a value of a square of a length of an edge of the object dividing an area of the object. When the compactness of the object is within the preset compactness range, the foreground object determining module 11 determines that the object is a foreground object. When the compactness of the object is outside the preset compactness range, the foreground object determining module 11 determines that the object is a background object. For example, the compactness of objects A, B, C, D, E, and F are respectively X1, X2, X3, X4, X5, and X6. The preset compactness range is between X7 and X8. When X2 is between X7 and X8, and X1, X3, X4, X5 and X6 are not between X7 and X8, the object B is determined as a foreground object and objects A, C, D, E, and F are determined as background objects.

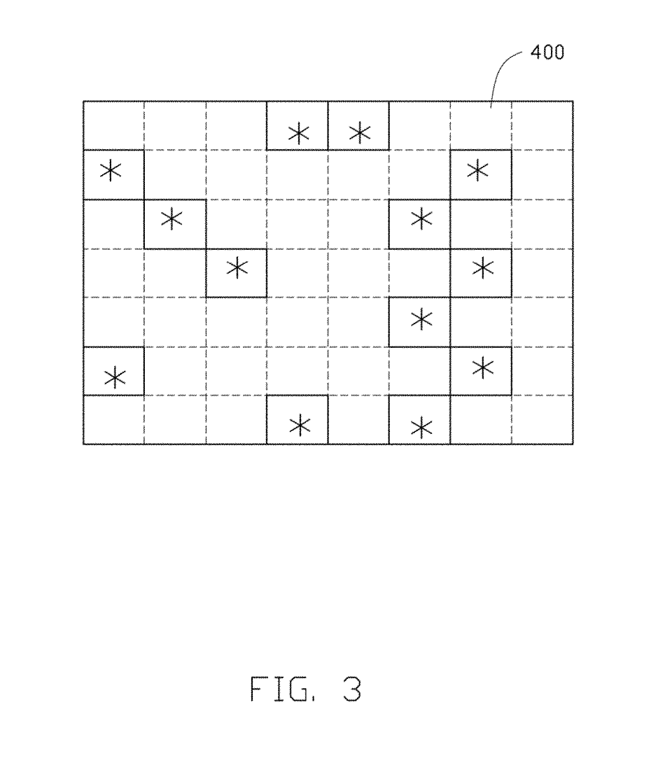

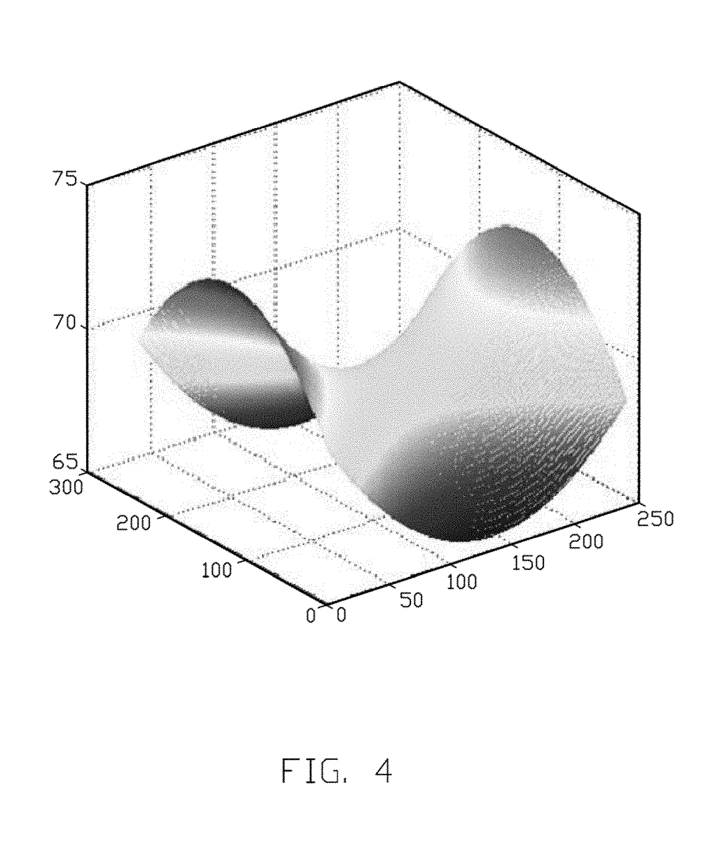

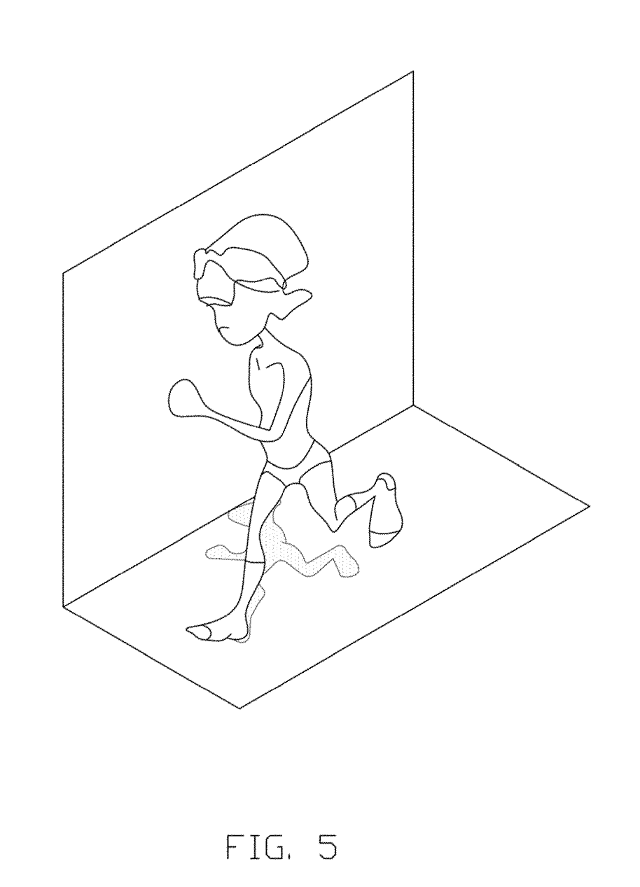

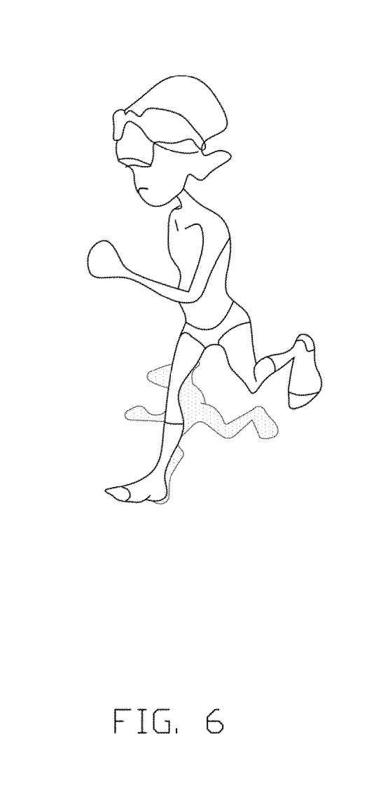

The sampling module 12 is configured to sample a number of pixels of each background object. The fitting module 13 is configured to obtain a pixel value by a function related to positions of pixels of the background object according to pixel values of sampled pixels. The pixel values of each pixel in the background object is consistent with the function related to pixel values. FIG. 3 illustrates a background object and a number of sampled pixels of a background object. The pixel value of each pixel of the background object is shown as FIG. 4. The background object removing module 14 is configured to subtract the pixel value of each pixel in each background object by the pixel value of each pixel of the image to obtain a foreground object image. FIG. 5 illustrates an image to be processed. FIG. 6 illustrates a foreground object within the image in FIG. 5.

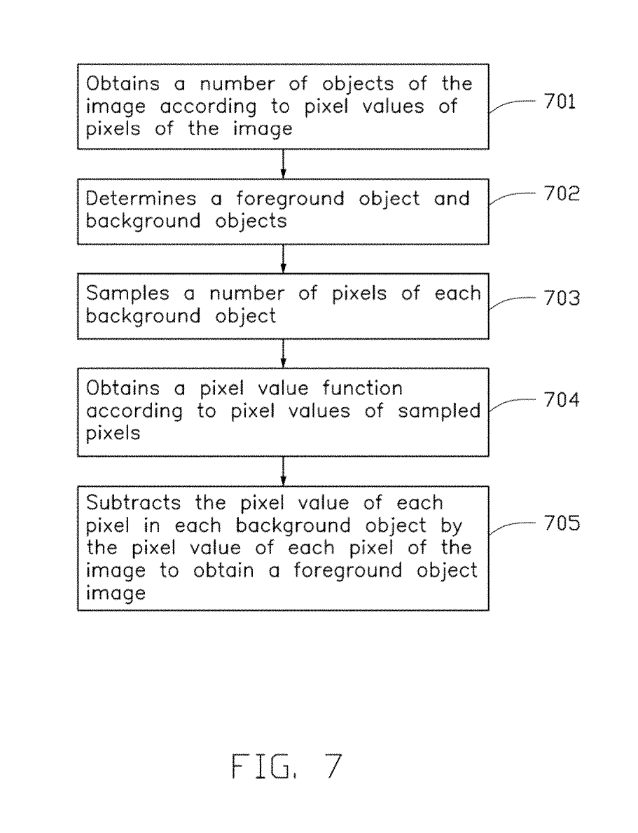

FIG. 7 illustrates an image processing method according to an embodiment. The method is employed in the image processing system 100. The order of blocks in FIG. 4 is illustrative only and the order of the blocks can change. Additional blocks can be added or fewer blocks may be utilized without departing from this disclosure. The exemplary method begins at block 701.

At block 701, the object obtaining module 10 obtains a number of objects within the image according to pixel values of pixels of the image. The pixel values of the pixels of the object are all greater than a preset pixel value.

At block 702, the foreground object determining module 11 determines an object as being a foreground object or a background object.

In an embodiment, the foreground object determining module 11 compares each object to a preset picture and determines an object as being in the foreground according to a similarity of the object and the preset picture. When the similarity of the object and the preset picture is greater than a preset value, the foreground object determining module determines that the object is a foreground object. When the similarity of the object and the preset picture is smaller than the preset value, the foreground object determining module determines that the object is a background object.

In another embodiment, the foreground object determining module 11 calculates a compactness of each object and determines a foreground object according to the compactness of each object and a preset compactness range. The compactness is a value of a square of a length of an edge of the object dividing an area of the object. When the compactness of the object is within the preset compactness range, the foreground object determining module 11 determines that the object is a foreground object. When the compactness of the object is outside the preset compactness range, the foreground object determining module 11 determines that the object is a background object.

At block 703, the sampling module 12 samples a number of pixels of each background object.

At block 704, the fitting module 13 obtains a function of pixel value according to pixel values of sampled pixels. The pixel value of each pixel in the background object is consistent with the pixel value function.

At block 705, the background object removing module 14 subtracts the pixel value of each pixel in each background object by the pixel value of each pixel of the image to distinguish and obtain a foreground object image.

The embodiments shown and described above are only examples. Even though numerous benefits and advantages of the present technology have been set forth in the foregoing description, together with details of the structure and function of the present disclosure, the disclosure is illustrative only, and changes may be made in the details, including in matters of shape, size, and arrangement of the parts within the principles of the present disclosure, up to and including the full extent established by the broad general meaning of the terms used in the claims.

What is claimed is:

1. An image processing system comprising:
an object obtaining module configured to obtain a plurality of objects of an image according to pixel values of pixels of the image, the pixel value of the pixel of the object being all great than a preset pixel;
a foreground object determining module configured to determine a foreground object and background objects of the image;
a sampling module configured to sample a plurality of pixels of each background object;
a fitting module configured to obtain a pixel value function related to positions of pixels of the background object according to pixel values of sampled pixels, the pixel value of each pixel in the background object is consistent with the pixel value function;
a background object removing module configured to subtract the pixel value of each pixel in each background object by the pixel value of each pixel of the image to obtain a foreground object image; and
at least one processor for executing programs associated with at least one of the object obtaining module, the foreground object determining module, the sampling module, the fitting module and the background object removing module.

2. The image processing system as claimed in claim 1, wherein the foreground object determining module compares each object to a preset picture and determines a foreground object according to a similarity of the object and the preset picture.

3. The image processing system as claimed in claim 2, wherein when the similarity of the object and the preset picture is greater than a preset value, the foreground object determining module determines the object is a foreground object.

4. The image processing system as claimed in claim 3, wherein When the similarity of the object and the preset picture is smaller than the preset value, the foreground object determining module determines the object is a background object.

5. The image processing system as claimed in claim 1, wherein the foreground object determining module calculates a compactness of each object and determine a foreground object according to the compactness of each object and a preset compactness range, the compactness is a value of a square of a length of a perimeter of an edge of the object dividing an area of the object.

6. The image processing system as claimed in claim 5, wherein when the compactness of the object is within the preset compactness range, the foreground object determining module determines the object is a foreground object.

7. The image processing system as claimed in claim 6, wherein when the compactness of the object is beyond the preset compactness range, the foreground object determining module determines the object is a background object.

8. An image processing system comprising:
an object obtaining module configured to segment an image to a plurality of objects according to pixel values of pixels of an image;
a foreground object determining module configured to determine a foreground object and background objects of the image, the pixel value of each pixel in the foreground object and background objects being all greater than a preset value;
a sampling module configured to sample a plurality of pixels of each background object;
a fitting module configured to obtain a pixel value function related to positions of pixels of the background object according to pixel values of sampled pixels, the pixel value of each pixel in the background object is consistent with the pixel value function;
a background object removing module configured to subtract the pixel value of each pixel in each background object by the pixel value of each pixel of the image to obtain a foreground object image; and
at least one processor for executing programs associated with at least one of the object obtaining module, the foreground object determining module, the sampling module, the fitting module and the background object removing module.

9. The image processing system as claimed in claim 8, wherein the foreground object determining module compares each object to a preset picture and determines a foreground object according to a similarity of the object and the preset picture.

10. The image processing system as claimed in claim 9, wherein when the similarity of the object and the preset picture is greater than a preset value, the foreground object determining module determines the object is a foreground object.

11. The image processing system as claimed in claim 10, wherein When the similarity of the object and the preset picture is smaller than the preset value, the foreground object determining module determines the object is a background object.

12. The image processing system as claimed in claim 8, wherein the foreground object determining module calculates a compactness of each object and determine a foreground object according to the compactness of each object and a preset compactness range, the compactness is a value of a square of a length of a perimeter of an edge of the object dividing an area of the object.

13. The image processing system as claimed in claim 12, wherein when the compactness of the object is within the preset compactness range, the foreground object determining module determines the object is a foreground object.

14. The image processing system as claimed in claim 13, wherein when the compactness of the object is beyond the preset compactness range, the foreground object determining module determines the object is a background object.

15. An image processed method comprising:
obtaining a plurality of objects of an image according to pixel values of pixels of the image, the pixel value of the pixel of the object being all great than a preset pixel;
determining a foreground object and background objects of the image;
sampling a plurality of pixels of each background object;
obtaining a pixel value function related to positions of pixels of the background object according to pixel values of sampled pixels, the pixel value of each pixel in the background object being consistent with the pixel value function; and
subtracting the pixel value of each pixel in each background object by the pixel value of each pixel of the image to obtain a foreground object image.

16. The image processing method as claimed in claim 15, wherein “determining a foreground object and background objects of the image” comprises:
comparing each object to a preset picture and determining a foreground object according to a similarity of the object and the preset picture.

17. The image processing method as claimed in claim 16, wherein when the similarity of the object and the preset picture is greater than a preset value, the foreground object determining module determines the object is a foreground object.

18. The image processing system as claimed in claim 17, wherein when the similarity of the object and the preset picture is smaller than the preset value, the foreground object determining module determines the object is a background object.

19. The image processing system as claimed in claim 15, wherein “determining a foreground object and background objects of the image” comprises:
calculating a compactness of each object and determine a foreground object according to the compactness of each object and a preset compactness range, the compactness is a value of a square of a length of a perimeter of an edge of the object dividing an area of the object.

20. The image processing method as claimed in claim 19, wherein when the compactness of the object is within the preset compactness range, the foreground object determining module determines the object is a foreground object.
